(19) United States
(12) Patent Application Publication
(10) Pub. No.: US 2018/0191281 A1
(43) Pub. Date: Jul. 5, 2018

(54) Operating Doubly-Fed Induction Generators as Virtual Synchronous Generators

(71) Applicant: Qingchang Zhong, Willowbrook, IL (US)

(72) Inventor: Qingchang Zhong, Willowbrook, IL (US)

(21) Appl. No.: 15/727,593

(22) Filed: Oct. 7, 2017

(30) Foreign Application Priority Data
Oct. 17, 2016 (GB) 1617589.5

(51) Int. Cl. H02P 9/00; H02J 3/18; F03D 7/02; F03D 9/25

(52) U.S. Cl. CPC H02P 9/007; H02J 3/1885; H02P 2101/15; F03D 9/25; F03D 7/0272

(57) ABSTRACT

This invention discloses a system and method to operate a doubly-fed induction generator (DFIG) as a grid-friendly virtual synchronous generator (VSG). It comprises a DFIG modeled as a virtual differential gear that links a rotor shaft driven by a prime mover, a virtual stator shaft coupled with a virtual synchronous generator G and a virtual slip shaft coupled with a virtual synchronous motor M, and a variable frequency drive that behaves as a virtual synchronous motor-generator set to regulate the speed of the virtual synchronous motor M so that the speed of the virtual stator shaft, i.e., the speed of the virtual synchronous generator G, is within a narrow band around the grid frequency even when the rotor shah: speed changes. As a result, a grid-connected DFIG can be controlled to behave like a virtual synchronous generator without using a PLL.

### CROSS-REFERENCE TO RELATED APPLICATIONS

This nonprovisional patent application claims the benefit of and priority under 35 U.S. Code ğ 119 (b) to U.K. Patent Application No. GB1617589.5 filed on Oct. 17, 2016, entitled “Operating Doubly-Fed Induction Generators as Virtual Synchronous Generators”, the contents of which are all hereby incorporated by reference herein in its entirety.

### TECHNICAL FIELD

This invention is concerned with control devices and control methods that operate a doubly-fed induction generator (DFIG) as a virtual synchronous generator (VSG). Possible application fields include smart, grid, renewable energy, such as wind energy and wave enemy, and aircraft power systems etc. Here, the application to wind energy is taken as an example.

### BACKGROUND

Wind energy has been regarded as a major means to combat the energy crisis and sustainability issues. In recent years, the technology of wind energy generation has undergone tremendous development. Variable-speed wind turbines are preferred by industry in order to maximize the utilization of wind energy. In these applications, the most commonly used generators include doubly-fed induction generators (DFIG) and permanent-magnet synchronous generators (PMSG). Because the stator windings of DFIG are directly connected to the grid and only the slip power goes through the back-to-back power electronic converter, the converter capacity needed is only a fraction of the rated power, which reduces the cost of investment. However, it does not have the full control over the total power, which may cause problems. Wind turbines equipped with PMSG often have a full-power back-to-back convener with the full control but the capacity of the power electronic converter is high. Most installed wind turbines adopt the PQ decoupling control strategy to control the current sent to the grid. However, this control method cannot effectively utilize the mechanical inertia stored in the turbine shaft, which causes problems to the grid stability when the penetration of wind energy becomes high. Far both systems, the real and reactive power must be injected to the grid according to the phase of grid voltage, which often involves the usage of a phase-locked loop (PLL) to track the phase variations. However, it has been known that PLLs suffer from nonlinear structure, time-consuming design and slow performance. What is even worse is that PLLs could cause wind energy systems out of synchrony and lead to instability. Therefore, a more grid-friendly interface for wind turbines is essential.

It is well known that large-scale power plants equipped with synchronous generators are responsible for maintaining the stability of power systems but when the penetration of wind energy systems reaches a certain level there is a need for wind energy systems to take part in the grid regulation. Recent research has shown that grid-connected converters can be controlled to behave like a VSG to take part in the regulation of system frequency and voltage. This concept can be applied to the control of wind turbines based on PMSG. Another concept is called virtual inertia, which is also able to provide frequency regulation but the implementation of the virtual inertia and frequency regulation requires the information of the grid frequency and the rate of change of frequency (ROCOF), which could not avoid the use of a PLL and could lead to poor performance because of the noises introduced in calculating the ROCOF. Recently, a self-synchronization method for converters has been proposed to remove the dedicated synchronization unit. The utilization of the VSG technique and the self-synchronization method to DFIG would ultimately smoothen the relationship between wind turbines and power systems but this requires deeper understanding because a DFIG has two power conversion channels: an induction generator and a back-to-back converter.

### BRIEF SUMMARY

This invention discloses the analogy between DFIG and (virtual) differential gears, and an electromechanical model to represent a DFIG as a virtual differential gear that links a rotor shaft driven by a prime mover, a virtual stator shaft coupled with a stator virtual synchronous generator G and a virtual slip shaft coupled with a slip virtual synchronous motor M. Moreover, a variable frequency drive, which consists of a rotor-side converter (RSC) and a grid-side converter (GSC), is adopted to regulate the speed of the slip virtual synchronous motor so that the speed of the stator virtual synchronous generator G is maintained within a narrow band around the grid frequency. A control strategy is then disclosed to operate a DFIG as a VSG without a PLL via controlling the GSC and RSC as a virtual synchronous motor-generator set. Both the RSC and the GSC are equipped with the self-synchronization mechanism of synchronous machines so there is no need to have a dedicated synchronization unit, e.g. a PLL. Such a system, denoted as DFIG-VSG, offers a friendly grid interface for DFIG-based wind turbines. It can support the grid in the dynamic state and send the available maximum power to the grid in the steady state.

This invention empowers DFIG-based wind turbines to have the benefits of PMSG-based wind turbines while maintaining the advantages of DFIG-based wind turbines, such as partial-scale power,high thermal capacity, high voltage level, and reduced system cost, size, weight and losses, as summarized in Table I. This will be even more crucial in the future because wind turbines are getting larger and larger, with the diameter over 190 m and the capacity of 10 MW or even with the capacity of 20 MW. The adoption of full-scale power converters is becoming a limiting factor and the industry is demanding for a solution that can continue using partial-scale power electronic converters and can have direct medium- or high-voltage connection with the grid, in order to save cost, reduce size and weight, and improve efficiency and reliability.

TABLE I
PROS AND CONS OF DIFFERENT WIND POWER GENERATION SYSTEMS

| | Thermal | Voltage | Converter | Grid- | | | | |
|---|---|---|---|---|---|---|---|---|
| | Capacity | Level | Power | friendly | Size | Cost | Efficiency | Controllability |
| DFIG-based | High | Can be high | Partial-scale | No | Small | Low | High | Low |
| PMSG-based | Low | Limited | Full-scale | Yes | Large | High | Low | High |
| DFIG-VSG | High | Can he high | Partial-scale | Yes | Small | Low | High | High |

### BRIEF DESCRIPTION OF THE DRAWINGS

The accompanying figures further illustrate the disclosed embodiments and, together with the detailed description of the disclosed embodiments, serve to explain the principles of the present invention.

FIG. 1 shows the typical configuration of a turbine-driven DFIG connected to the grid.

FIG. 2 illustrates a (virtual) differential gear with three shafts.

FIG. 3 shows the disclosed electromechanical model of a turbine-driven grid-connected DFIG modeled as a virtual differential gear and controlled by a variable frequency drive that is operated as a virtual synchronous motor-generator set.

FIG. 4 shows the controller to operate the grid-side converter as a virtual synchronous machine GS-VSM.

FIG. 5 shows the controller to operate the rotor-side converter as a virtual synchronous generator RS-VSG.

FIG. 6 shows the simulation results front the operation of a DFIG-VSG.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art.

The terminology used herein for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise,the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or” as used herein nay include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least: in part upon context, may be used to describe any feature, structure, or characteristic in a singular sense or may be used to describe combinations of features, structures or characteristics in a plural sense. Similarly, terms, such as “a” a or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

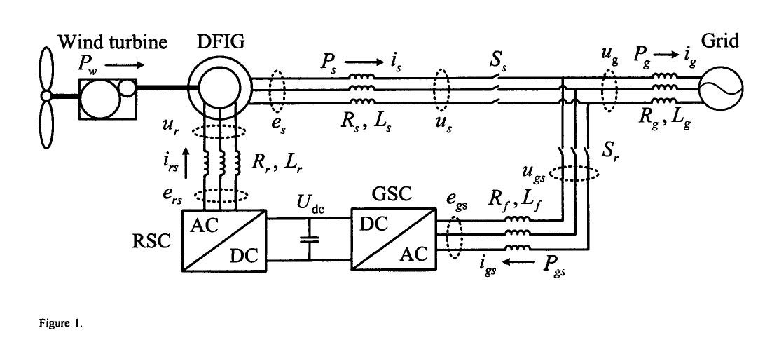

It is well recognized that the power flow of DFIG has two channels one through the stator windings and the other through the rotor windings, often coupled with a back-to-back converter, as shown in FIG. 1. As mentioned before, the main objective of this paper is to operate a DFIG as a virtual synchronous machine. Hence, it is necessary to make both channels to behave like virtual synchronous machines. For the power flow channel through the back-to-back converter, the grid-side converter (GSC) can be operated to behave like a virtual synchronous motor (denoted as GS-VSM) with the inertia J_{gs} and the angular speed ω_{gs}. Conceptually, the rotor-side converter (RSC) can also be operated as a virtual synchronous generator (denoted as RS-VSG) to provide the voltage for the rotor windings, but the details need to be determined. What is even unclear is the power flow channel through the stator windings. The relationship among the stator, the rotor and the slip needs to be clarified in order to clearly understand the operation of DFIG as a VSG.

In order to address this challenge, the concept of differential gears is borrowed. A differential gear is a mechanical device that consists of some gears and three input/output shafts. Any of the three shafts can serve as either input or output as long as there is one input and one output at any given moment. Its main purpose is to sum or differentiate shaft speeds while maintaining constant torque ratio between shafts. Because of this, a differential gear reduces the three degrees of freedom to two. Differential gears are nowadays widely used in automobiles so that wheels on each side can rotate at different speeds when making a tune. It was actually used in the first historically verifiable Chinese south-pointing chariot invented by Ma, Jun. in 227-239 AD, which provided the cardinal direction as a non-magnetic, mechanized compass. It was possibly used in China as early as in 30 BC-20 BC¹.

Back to the DFIG, a virtual stator shaft rotating at the speed ωₛ can be introduced. If it rotates synchronously with the grid frequency ω_{g}, then the virtual stator shaft works with the stator windings to form a virtual synchronous generator. Moreover, a virtual slip shaft that rotates synchronously with the slip frequency ωᵣₛ can be introduced to form another virtual synchronous machine. Since the slip speed/frequency ωᵣₛ of a DFIG is defined as

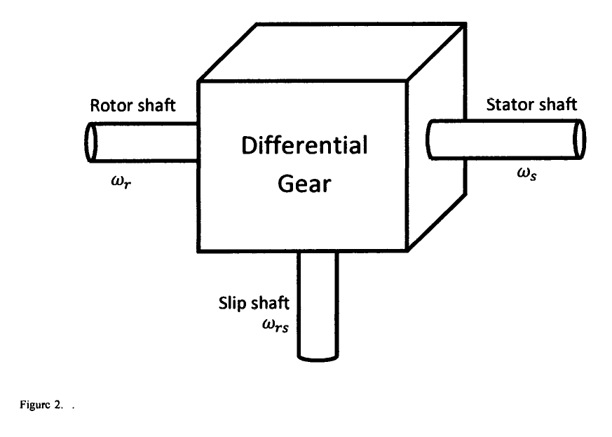

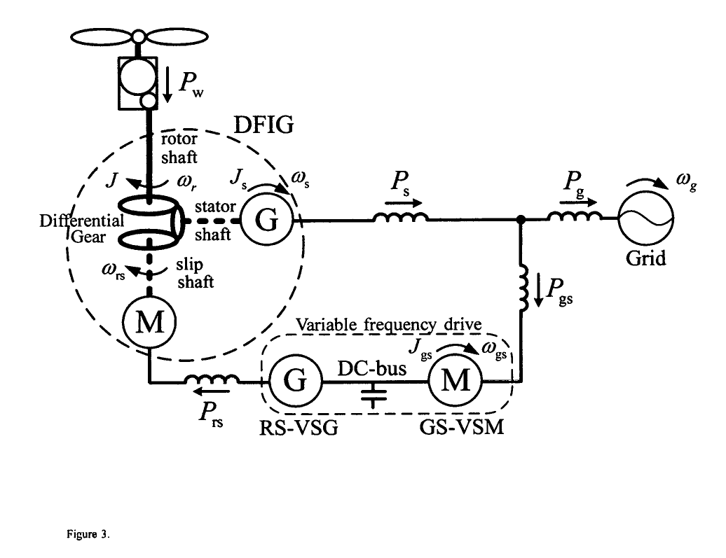

ωᵣₛ=ωₛ−ωᵣ, (1)

where is the speed of the rotor shaft, the stator shaft, the rotor shaft and the slip shaft can be regarded as being linked together through a differential gear, as illustrated in FIG. 2. The rotor shaft is the input shaft driven by the prime mover and the stator shaft is the output shaft to drive the stator synchronous generator while the slip shaft can be either input or output connected to the slip synchronous machine. For the varying rotor speed ωᵣ, it is always possible to control the slip shaft speed ωᵣₛ so that the stator shaft rotates synchronously with the grid frequency. Without loss of generality. ωₛ and ωᵣ are assumed to be positive but ωᵣₛ can be positive or negative, depending on whether the rotor speed ωᵣ is lower or higher than the speed ωₛ. As a result, the equivalent electromechanical model of the system in FIG. 1 in terms of virtual synchronous machines is obtained as shown in FIG. 3. The DFIG is equivalent to a differential gear that has a rotor shaft driven by the prime mover, a stator shaft coupled with a synchronous generator (G) and a slip shaft coupled with a synchronous motor (M). The positive sign in FIG. 3 is defined for the case when the rotor speed ωᵣ is lower than the synchronous speed ωₛ, on which the analysis in the sequel will be based. When ωᵣ ≥ωₛ, the slip shaft changes the direction of rotation ω act as an output shaft and the power flow in the rotor channel changes direction too. Note that because of the energy conservation law, the torques on the three shafts are the same. If there is no torque on any of the three shafts, then there is no torque on all of them. The back-to-back converter plays the role of a variable frequency drive to control the speed of the slip synchronous motor. The GSC can be operated as a virtual synchronous motor (GS-V SM) while the RSC can be operated as a virtual synchronous generator (RS-VSG), thus forming a virtual synchronous motor-generator set.

As mentioned, the overall objective is to control a grid-connected DFIG as a VSG. In other wards, the net real power P_{g} and reactive power Q_{g} exchanged with the grid should be regulated according to the frequency dynamics and voltage dynamics of a VSG. Since the stator windings are connected to the grid directly, it is desirable for the majority of real power and reactive power to go through the stator windings while the GSC is only responsible for maintaining the DC-bus voltage to facilitate the control ¹https.//en.wikipetha.org/wiki/Differential_(mechanical_device). of the RSC. Hence, the back-to-back converter should be a local channel inside the system.

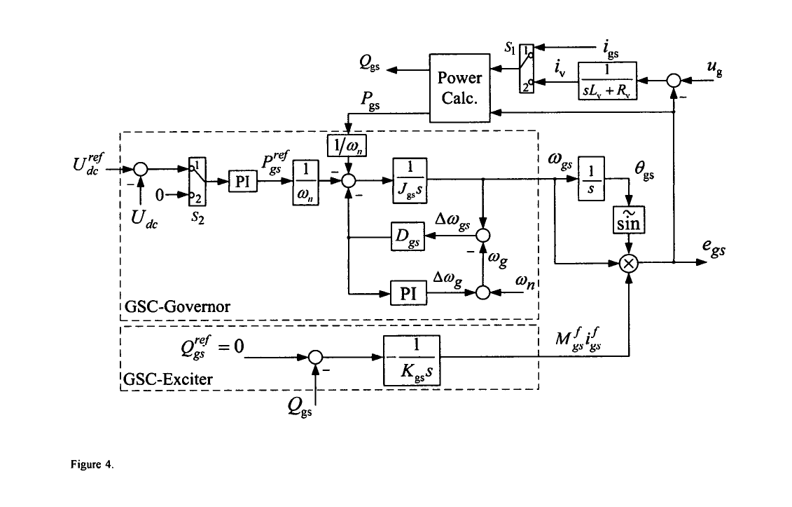

The role of the grid-side converter is to maintain the DC-bus voltage U_{dc} of the back-to-back converter at the reference voltage U_{dc}^{ref}, via operating this PWM-controlled converter as a virtual synchronous machine (denoted as GS-VSM). In practice, energy storage systems, such as electrolytic capacitors and/or batteries, can be connected to the common DC bus to buffer the power imbalance between the RS-VSG and the GS-VSM. The proposed controller for the GS-VSM is shown in FIG. 4, where the grid frequency ω_{g} is obtained through a PI controller. It also regulates the speed/frequency ω_{gs} of the GS-VSM to the grid frequency ω_{g}. The GS-VSM includes the built-in swing equation

$${J}_{gs} \cdot \frac{d {ω}_{gs}}{dt} = {T}_{gs} - {T}_{gs}^{ref} - {D}_{gs} ( {ω}_{gs} - {ω}_{g} ) ,$$

where J_{gs} is the virtual inertia of the GS-VSM,

$${T}_{gs} = \frac{{P}_{gs}}{{ω}_{n}}$$

is the electromagnetic torque calculated from the real power P_{gs},

$${T}_{gs}^{ref} = \frac{{P}_{gs}^{ref}}{{ω}_{n}}$$

is the corresponding load torque generated by the PI controller that regulates the DC-bus voltage U_{dc}, and D_{gs} is the virtual friction/damping coefficient. The PI controller that regulates the output of the block D_{gs} to be zero makes sure that the GS-VSM frequency ω_{gs} is synchronized with the grid frequency ω_{g}. Hence, there is no need to have a dedicated synchronization unit, e.g. a PLL. The controller includes a GSC exciter consisting of a PI controller that regulates the reactive power Q_{gs} to track the reference reactive power Q_{gs}^{ref} and generate the virtual field excitation M_{gs}^{f}i_{gs}^{f}. The reference reactive power Q_{gs}^{ref} can be set to zero se that the rotor channel does not contribute any reactive power, which helps reduce the capacity (and cost) of the converter. The back-EMF γ_{gs} of the GS-V,SM is generated as

ϵ_{gs}−M_{gs}^{f}i_{gs}^{f}ω_{gs} [symbol] θ_{gs}, (2)

which can be converted into PWM pulses to drive the power electronic switches of the GSC. Here,

$${θ}_{gs} = {[ \begin{matrix}sin {θ}_{gs} & sin ( {θ}_{gs} - \frac{2 π}{3} ) & sin ( {θ}_{gs} + \frac{2 π}{3} )\end{matrix} ]}^{T}$$

represents the three-phase sinusoidal vector. Hence, the terminal voltage u_{gs} satisfies

$${u}_{gs} = {R}_{f} {i}_{gs} + {L}_{f} \frac{{di}_{gs}}{dt} + {e}_{gs} , \qquad ( 3 )$$

where R_{f} and L _{f} are the resistance and inductance of the RL filter of the GSC. It is the same as the grid voltage u_{g} once the rotor circuit breaker Sᵣ is turned ON.

Note that, as shown in FIG. 4, the real power P_{gs} and reactive power Q_{gs} are calculated according to the generated back-EMF e_{gs} and the sampled current i_{gs}. This helps reduce the number of voltage sensors needed and, hence, the cost.

As shown in FIG. 4, the controller that regulates the virtual frequency ω_{gs} is similar to the function of a governor. The governor has three cascaded loops, including the inner frequency loop, the middle torque loop and the outer DC-link voltage loop. The first two loops perform the function of a VSM while the third loop regulates the DC-link voltage to generate the desired real power reference P_{gs}^{ref} for the VSM.

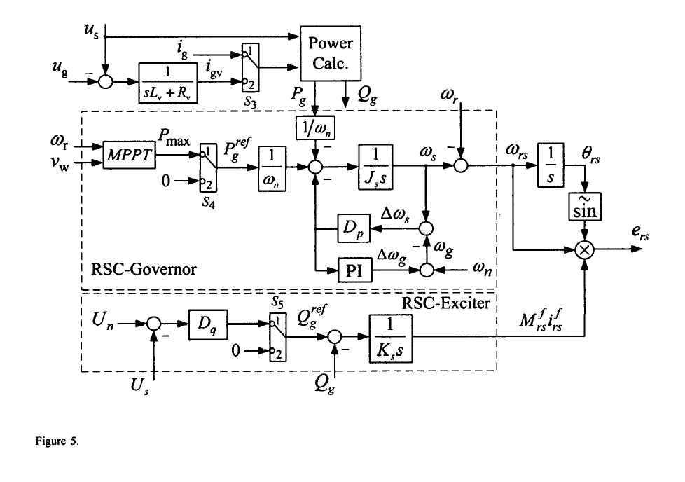

As mentioned before, the DFIG stator is to be controlled as a virtual synchronous generator, which needs to be realized by controlling the rotor-side converter. FIG. 5 shows the control structure.

According to the electromechanical model presented in FIG. 3, the virtual stator shaft rotating at ωₛ is expected to synchronize with the grid frequency ω_{g}, which is obtained through a PI controller. At the same lime, the real power exchanged with the grid is regulated through the swing equation

$${J}_{s} \cdot \frac{d {ω}_{s}}{dt} = {T}_{g}^{ref} - {T}_{g} - {D}_{p} ( {ω}_{s} - {ω}_{g} ) ,$$

where Jₛ is the virtual inertia of the stator shaft, T_{g}^{ref}=P_{g}^{ref}/ωₙ is the mechanical torque applied to the stator shaft, T_{g}=P_{g}/ωₙ is the electromagnetic torque and Dₚ is the frequency droop coefficient or the virtual friction coefficient. Note that the real power P_{g} is obtained by measuring the grid current i_{g} and the terminal voltage uₛ, which is the same as the grid voltage u_{g} when the stator circuit breaker Sₛ is ON. Hence, this reflects the net real power exchanged with the grid. In other words, the whole power extracted by the wind turbine (less losses). The virtual stator shaft and the stator windings together form a virtual synchronous generator.

Note that the stator shaft speed ωₛ cannot be directly controlled because the stator windings are not supplied by a controllable voltage source. Because of the electromechanical relationship given in (1) and the electromechanical model established in the previous section, the stator shaft speed ωₛ can be maintained at the grid frequency ω_{g} by controlling the slip shaft speed ωᵣₛ, i.e., the frequency of the RSC voltage, even when the rotor shaft speed ωᵣ changes.

The virtual slip shaft is the shaft of the slip synchronous motor, of which the speed is controlled by the RSC as an RS-VSG. Similar to the operation of synchronverters, the field excitation Mᵣₛ^{f}iᵣₛ^{f} of the RS-VSG can be generated through an integrator

$$\frac{1}{{K}_{s} s}$$

or a PI controller that regulates that reactive power Q_{g} to its reference value Q_{g}^{ref}.

Moreover, a voltage droop controller can be added through the droop coefficient D_{q} so that the RS-VSG can regulate the RMS value of the terminal voltage uₛ around its nominal value Uₙ. Note that the terminal voltage uₛ, instead of the rotor voltage, is used here. Hence, the reactive power reflects the net reactive power exchanged with the grid. This does not only reduce the number of voltage sensors needed but also facilitates the control design. Otherwise, it would have been difficult to determine the reference values for the voltages, currents and power of the rotor windings because of the varying operational condition. The rotor currents and voltages are only intermediate variables and there is no need to measure them for the purpose of control.

Because of (1), the slip shaft speed ωᵣₛ=ωₛ−ωᵣ can be integrated to obtain the slip shaft angle θᵣₛ. As a result, the control voltage of the RSC can be formed as

ϵᵣₛ=Mᵣₛ^{f}iᵣₛ^{f}ωᵣₛ [symbol] θᵣₛ. (4)

according to the dynamics of synchronous machines. This can be converted into PWM pulses to drive the RSC and generate the rotor winding voltage

$${u}_{r} = - {R}_{r} {i}_{rs} - {L}_{r} \frac{{di}_{rs}}{dt} + {e}_{rs} ,$$

where Rᵣ and Lᵣ are the rotor resistance and leakage inductance, to regulate the speed of the slip synchronous motor as ωᵣₛ.

As is well known, it is crucial to synchronize a ⁻voltage source before it is connected to another voltage source. The connection of the GSC to the grid is not a problem because it is operated as a rectifier. The GS-VSM controller can be started with the mode switches S₁ and S₂ at Position 2 and the rotor circuit breaker Sᵣ can be turned ON when needed. There may be a large inrush current to charge the DC-bus capacitors at the beginning but this can be easily solved. After it is connected to the grid, the controller starts regulating the voltage e_{gs} to the grid voltage u_{g} through the virtual current

$${i}_{υ} = \frac{{u}_{g} - {e}_{gs}}{{L}_{υ} s + {R}_{υ}} , \qquad ( 5 )$$

according to the voltage difference between e_{gs}, and the grid voltage u_{g}. This virtual current replaces the current i_{gs} when calculating the real power P_{g} and reactive power Q_{g}. The voltage e_{gs}, can be sent out to the switches after PWM conversion after the synchronization is achieved, which avoids large inrush currents when enabling the PWM signals. Then the mode switches S₁ and S₂ can be turned to Position 1 to start normal operation.

The connection of the stator windings to the grid also needs some care. The stator voltage uₛ needs to be synchronized with the grid voltage u_{g} before the stator circuit breaker Sₛ is turned ON. As shown in FIG. 5, three mode switches S₃, S₄ and S₅ are introduced to operate the controller in the normal operational mode (at Position 1) or in the self-synchronization mode (at Position 2). When it is in the self-synchronization mode, the reference real power P_{g}^{ref} and reactive power Q₉^{ref} are all set at zero. Moreover, a virtual impedance L_{υ}s+R_{υ}is introduced to generate a virtual grid current

$${i}_{gv} = \frac{{u}_{s} - {u}_{g}}{{L}_{v} s + {R}_{v}} , \qquad ( 6 )$$

according to the voltage difference between the stator voltage u_{g} and the grid voltage u_{g}. This virtual current replaces the grid current i_{g} when calculating the real power P_{g} and reactive power Q_{g}. Hence, before turning Sₛ ON, the controller regulates the stator voltage u₃ until it is the same as u_{g}, in other words, until it is synchronized, by regulating the real power and the reactive power to zero. Once it is synchronized, the mode switches S₃, S₄ and S₅ can be turned to Position 1 and the stator circuit breaker S, can be turned ON to start normal operation.

To extract the maximum power from the wind is very important and there are many MPPT algorithms available. Since this is not the focus of this paper, the maximum power Pₘₐₓ under a certain wind speed v_{w} is adopted as the real power reference P_{g}^{ref}. Since the RS-VSG controls the net real power exchanged with the grid, in practice, P_{g}^{ref} should be slightly smaller than Pₘₐₓ to cover power losses. As is shown in FIG. 5, Δωₛ is regulated to zero in the steady state, which means ωₛ=ω_{g}. Hence, P_{g}=P_{g}^{ref} in the steady state, i.e., the reference real power P_{g}^{ref} is injected into the grid, even if the grid frequency ω_{g} deviates from the nominal frequency ωₙ by Δω_{g}.

The reactive power is regulated according to the difference between the terminal voltage U_{g} and the rated voltage Uₙ, via the voltage droop coefficient

$${D}_{q} = - \frac{Δ Q}{Δ U} = - \frac{Δ Q}{{Q}_{n}} \cdot \frac{{U}_{n}}{Δ U} \cdot \frac{{Q}_{n}}{{U}_{n}} = {D}_{q}^{pu} \cdot \frac{{Q}_{n}}{{U}_{n}} , \\ where$$

$${D}_{q}^{pu} = - \frac{Δ Q}{{Q}_{n}} \cdot \frac{{U}_{n}}{Δ U}$$

is the normalized voltage droop coefficient 100% increase of reactive power corresponds to 10% of voltage drop then D_{q}^{pu}=10.

It is also possible for the wind turbine to take part in the frequency regulation by disabling the PI controller that regulates Δωₛ to 0, to make Δω_{g}=0. In this case, the actual real power P_{g,} sent to the grid in the steady state is no longer P_{g}^{ref} but

P_{g}−P_{g}^{ref}−Dₚ(ωₛ−ωₙ)ωₙ,

where Dₚ is the frequency droop coefficient defined as

$${D}_{p} = - \frac{Δ T}{Δω} = - \frac{Δ T}{{T}_{n}} \cdot \frac{{ω}_{n}}{Δω} \cdot \frac{{T}_{n}}{{ω}_{n}} = {D}_{p}^{pu} \cdot \frac{{P}_{n}}{{ω}_{n}^{2}} , \\ where \\ {D}_{p}^{pu} = - \frac{Δ T}{{T}_{n}} \cdot \frac{{ω}_{n}}{Δω} \qquad ( 7 )$$

is the normalized frequency droop coefficient. If 100% increase of real power corresponds to 1% drop of frequency then Dₚ^{pru} =100.

The system shown in FIG. 1 with the parameters in Table II was simulated to validate the proposed strategy. The back-to-back converter was implemented with IGBT universal bridges and the switching frequency was set to 5 kHz.

The simulation was carried out according to the following sequence of actions:
At 0 s, the system was initialized with the wind speed of 8 m/s and the turbine rotor initial speed of 0.8 pu. All IGBT switches were OFF. Both circuit breakers Sₛ and Sᵣ were OFF. All mode switches were at Position 2.
At 0.1 s, the rotor circuit breaker Sᵣ was turned ON. And at 0.3 s, the PWM signals to the GSC were enabled and the mode switches S₁ and S₂ were turned to Position 1. The GS-VSM was started to regulate the DC-link voltage.
At 1 s, the PWM signals to the RSC were enabled and the RS-VSG started to synchronize the DFIG with the grid. At 2 s, the circuit breaker Sₛ was turned ON and the mode switches S₃, S₄ and S₅ were turned to Position 1. The DFIG started to inject power into the system at the maximum power point P_{g}^{ref}=Pₘₐₓ.
At 4 s, the grid voltage dropped by 5%, and at 6 s the grid voltage returned back to normal.

TABLE II
DFIG-VSG PARAMETERS

| Symbol | Description | Value |
|---|---|---|
| Rₛ, Lₛ | Stator resistance, leakage inductance | 0.023 pu, 0.018 pu |
| Rᵣ, Lᵣ | Rotor resistance, leakage inductance | 0.16 pu, 0.016 pu |
| Lₘ | Mutual inductance | 2.9 pu |
| Pₙ, Qₙ | Rated real and reactive power | 1.5 MW, 1.2 Mvar |
| Uₙ, Uᵣ | Rated stator and rotor voltages | 690 V, 2200 V |
| fₙ | Rated frequency | 50 Hz |
| R_{f}, L_{f} | Filter resistance and inductance | 0.05 pu, 0.1 pu |
| C, U_{dc} | DC-bus capacitance and voltage | 10000 μF, 2000 V |
| Jₛ, J_{gs} | RSC and GSC virtual inertia | 22.8, 6.84 kg · m² |
| τ_{f} | Time constant of frequency loops | 0.015 s |
| J | Turbine inertia | 11.7 kg · m² |
| Kₛ, K_{gs} | RSC and GSC voltage regulation | 3.3 · 10³, 5.4 · 10⁴ |
| τᵤ | Time constant of RSC voltage loop | 0.006 s |
| | Time constant of GSC voltage loop | 0.33 s |
| | RSC self-sync. PI controller | 1 · 10⁻¹⁰, 1 · 10⁻⁹ |
| | GSC self-sync. PI controller | 3 · 10⁻¹⁰, 3 · 10⁻⁹ |
| | DC-bus voltage PI controller | 10, 100 |
| Rᵤ, Lᵤ | Impedance for synchronization | 0.02 Ω, 0.4 mH |

At 8 s, the wind speed increased to 14 m/s.
At 10 s, the grid frequency dropped to 49.75 Hz, and at 12 s, it returned to 50 Hz.

In order to clearly show the dynamic response, only the Phase A of the instantaneous AC voltages and currents are shown in the simulation results.

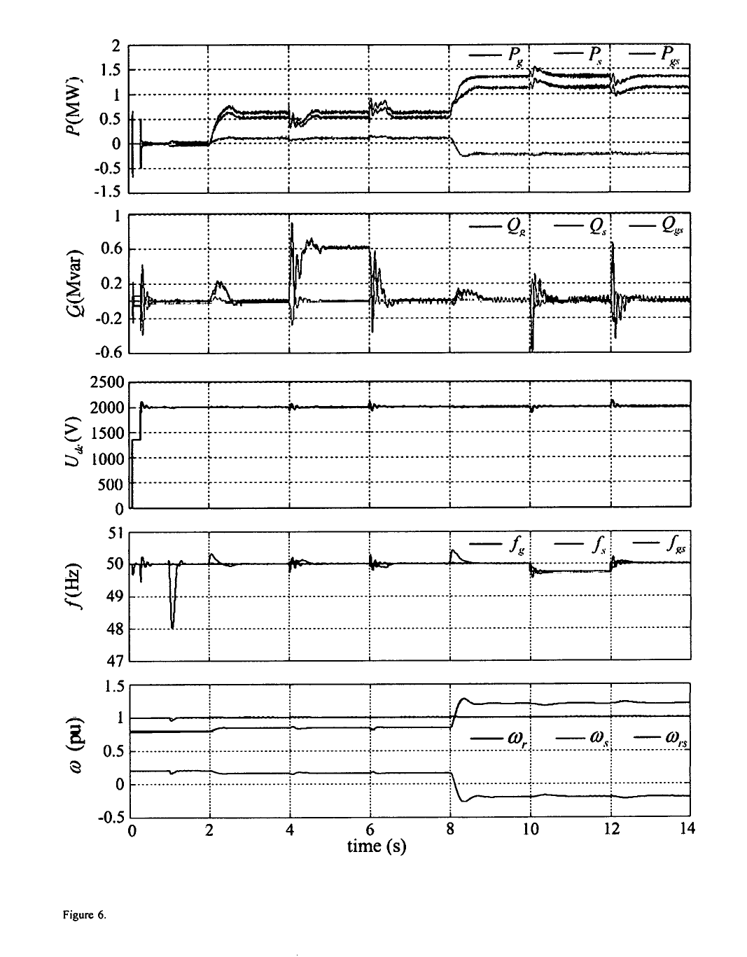

FIG. 6 shows the response of the DFIG-VSG during the whole process. After the GSC was connected to the grid at 0.1 s, both the active power and the reactive power had some small spikes but both were below the capacity. At 0.3 s, the DC-bus voltage was established. After the RSC was enabled at 1 s, a small amount of real power was drawn from the grid by the GSC to maintain the DC-bus voltage. After the stator circuit breaker Sₛ was turned ON at 2 s, the real power sent to the grid gradually increased to the maximum power corresponding to the wind speed of 8 m/s. The rotor speed increased to 0.84 pu and the slip speed reduced to 0.16 pu. The reactive power had some coupling effect but returned to zero. Note that the response of the GSC is faster than the response of the RSC, which is in line with the assumption that the GSC has a faster dynamics in order to better maintain the DC-bus voltage. At 4 s the grid voltage dropped by 5%. The reactive power of the DFIG stator sent to the grid increased to 0.6 MVAr (50% of the rated reactive power according to the voltage droop coefficient); the GSC also sent some reactive power initially but then regulated it to zero. Hence, both channels contributed to the voltage support initially but the stator took the main responsibility. This led to temporary reduction of the real power sent to the grid by the stator windings, which helps reduce the stress on the machine. The real power drawn by the GSC did not change much. When the voltage recovered at 6 s, the GSC drew some reactive power from the grid and the stator stopped sending reactive power to the grid. Once again, the response of the GSC was much faster than that of the RSC. The GS-VSM frequency did not change much but the stator frequency did respond to the voltage change accordingly. When the wind speed increased at 8 s, the real power sent to the grid was increased. The rotor speed increased from 0.84 pu to 1.2 pu and the slip speed reduced to −0.2 pu. As a result, the GS-VSM also started injecting real power to the grid, i.e. the real power became negative. The reactive power had some small dynamics but then returned to zero. The GS-VSM frequency did not have any noticeable change but the stator frequency increased and then returned to the grid frequency. At 10 s, when the grid frequency dropped abruptly by 0.25 Hz, the GS-VSM quickly followed the grid frequency and maintained the DC-bus voltage stable. The stator frequency also followed the grid frequency, which forces the DFIG stator to release some kinetic energy to support the grid frequency as the rotor speed temporarily dropped by 0.03 pu. At 12 s, the grid frequency returned to 50 Hz. The DFIG stored some kinetic energy by increasing the rotor speed and temporarily reducing the real power to support the grid frequency. Hence, the DFIG-VSG has demonstrated the feasibility of increasing the equivalent inertia and taking advantage of the kinetic energy stored in the turbine rotor to support the grid frequency. During the whole process, the DC-bus voltage was maintained very well because the GS-VSM was designed to have faster responses than the RS-VSG. Indeed, the GS-VSM frequency f_{gs}, tracked the grid frequency f_{g} faster than the stator frequency fₛ, even when the grid frequency dropped and recovered.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. A system and method to operate a doubly-fed induction generator (DFIG) as one virtual synchronous generator (VSG), comprising
a DFIG modeled and controlled as a virtual differential gear that links a rotor shaft driven by a prime mover, a virtual stator shaft coupled with a stator virtual synchronous generator G and a virtual slip shaft coupled with a slip virtual synchronous motor M, and
a variable frequency drive that behaves as a virtual synchronous motor-generator set to regulate the speed of the slip virtual synchronous motor M so that the speed of the virtual stator shaft, i.e., the speed of the stator virtual synchronous generator G, is within a narrow band around the grid frequency.

2. A system as claimed in claim 1 in which the virtual synchronous motor-generator set of the variable frequency drive consists of a rotor-side converter that is controlled to behave as a virtual synchronous generate)ted as RS-VSG, and a grid-side converter that is controlled to behave as a virtual synchronous motor, denoted as GS-VSM, which share a common DC bus.

3. A system as claimed in claim 2 in which the real power of the GS-VSM is controlled by a GS-VSM controller through regulating the DC-bus voltage.

4. A system as claimed in claim 2 in which the reactive power of the GS-VSM in the steady state is controlled at around zero by the CS-VSM controller to generate the field excitation for the GS-VSM.

5. A system as claimed in claim 2 in which the RS-VSG is controlled by an RS-VSG controller to generate a voltage having a variable frequency according to the variable rotor speed.

6. A system as claimed in claims 2, 3 and 4 in which the GS-VSM controller generates an internal frequency to track the grid frequency without using a dedicated synchronization unit.

7. A system as claimed in claims 2, and 5 in which the RS-VSG controller generates an internal frequency according to the total real power sent to the grid to track the grid frequency without using a dedicated synchronization unit.

8. A system as claimed in claims 2, 5 and 7 in which the RS-VSG controller regulates the total reactive power sent to the grid according to a given reactive power reference to generate the field excitation for the RS-VSG that feeds the slip virtual synchronous motor M.

9. A system as claimed in claims 1, 2, 5, 7 and 8 in which the reactive power reference is generated by scaling the difference between the stator RMS voltage and the rated grid RMS voltage.

10. A system as claimed in claims 2, 3 and 4 in which the GS-VSM controller contains a virtual impedance to generate a virtual current according to the difference of the GS-VSM voltage and the grid voltage to replace the grid-side current to bring the GS-VSM in synchronization with the grid.

11. A system as claimed in claims in which the RS-VSG controller contains a virtual impedance to generate a virtual current according to the difference of the stator voltage and the grid voltage to replace the grid current to bring the RS-VSG in synchronization with the grid.

12. A system as claimed in claim 2 in which an energy storage system is connected to the common DC bus to buffer the power imbalance between the RS-VSG and the GS-VSM.

13. A system as claimed in claim 12 in which the energy storage system consists of electro capacitors and/or batteries.

14. A system as claimed in claims 2-9 and 12 in which the GS-controller acts faster than the RS-VSG controller so that the DC-bus voltage is maintained within an acceptable band around a given rated voltage.
